(19) United States
(12) Patent Application Publication
(10) Pub. No.: US 2021/0180388 A1
(43) Pub. Date: Jun. 17, 2021

(54) OPENING AND CLOSING BODY DRIVE DEVICE

(71) Applicant: HI-LEX Corporation, Hyogo (JP)

(72) Inventor: Atsushi JOKO, Osaka (JP)

(73) Assignee: HI-LEX Corporation, Hyogo (JP)

(21) Appl. No.: 16/759,737

(22) PCT Filed: Oct. 30, 2018
(86) PCT No.: PCT/JP2018/040356

§ 371 Date: Apr. 28, 2020

(30) Foreign Application Priority Data
Oct. 30, 2017 (JP) 2017-209245

(51) Int. Cl. E05F 15/622

(52) U.S. Cl. CPC E05F 15/622; E05Y 2201/434; E05Y 2201/70; E05B 81/14; E05Y 2400/36; E05Y 2400/32; E05Y 2900/546; E05Y 2201/702

(57) ABSTRACT

An opening and closing body drive device includes: an opening and closing body; a latch mechanism; an opening and closing body drive section; a control section; and a movement sensor, wherein the control section includes a middle reference count value and a pushing count value, and the control section compares the current count value acquired by the movement sensor when the opening and closing body becomes the predetermined state with the latch mechanism and the middle reference count value with each other and corrects the current count value, and the control section assumes that the opening and closing body has arrived the fully-closed position when the opening and closing body has moved by an amount corresponding to the pushing count value from a count value corresponding to the middle reference count value and stops driving of the opening and closing body drive section.

### TECHNICAL FIELD

The present invention relates to an opening and closing body drive device.

### BACKGROUND ART

For drive devices each configured to open and close an opening and closing body by a drive section, electrically-powered drive sections are adopted in some cases as in opening and closing devices for back doors of vehicles. In a case where opening and closing of an opening and closing body is performed by the electrically-powered drive section, an attempt to drive the drive section further in a state where the opening and closing body has already moved to a fully-open position or a fully-closed position causes application of an excessive load onto the drive section. Thus, suppression of this excessive load is made by stopping the drive section in accordance with position information, using a pulse count value outputted from a pulse encoder for the position of the opening and closing body.

With the position information using a pulse count value, however, there occurs a case where the position information on the opening and closing body by the pulse count value deviates from the actual position of the opening and closing body due to, for example, collision of the opening and closing body with a foreign object. As a device that does not generate such a difference between the position information and the actual position of the opening and closing body as described above, a vehicular opening and closing body control device which determines that the opening and closing body has arrived at the fully-closed position, when a latch mechanism that locks movement of the opening and closing body turns into a half-latched state is disclosed in Patent Literature (hereinafter, referred to as “PTL”) 1, for example.

### CITATION LIST

### Patent Literature

PTL 1

Japanese Patent Application Laid-Open No. 2003-184429

### SUMMARY OF INVENTION

### Technical Problem

However, in a case where the opening and closing body drive section which drives the opening and closing body for opening and closing has a cause of preventing the opening and closing body from closing, such as a case where the opening and closing body drive section has a self-lock mechanism, it is difficult to move the opening and closing body to a fully-closed position by a driving force of the latch mechanism once the latch mechanism turns into the half-latched state. For this reason, unless the opening and closing body is moved to a closing direction such that the movement amount of the opening and closing body in the half-latched state becomes an appropriate movement amount, the attempt to move the opening and closing body further in the closing direction is made although the opening and closing body has already arrived at the fully-closed position, and thus the attempt results in application of an excessive load onto the opening and closing body drive section.

An object of the present invention is to provide an opening and closing body drive device capable of suppressing application of an excessive load onto an opening and closing body drive section at the time of driving an opening and closing body.

### Solution to Problem

An opening and closing body drive device according to the present invention includes:

an opening and closing body;

a latch mechanism which causes a striker to engage with and/or disengage from a latch and to set the opening and closing body in a closed state or an open state;

an opening and closing body drive section which causes the opening and closing body to move between a fully-open position and a fully-closed position;

a control section which controls driving of the opening and closing body drive section; and

a movement sensor which outputs movement information on the opening and closing body, in which

the control section includes a middle reference count value which is a previously set count value when the latch mechanism is set in a predetermined state, and a pushing count value which causes the opening and closing body to be set in a fully-closed state by adding and/or subtracting the pushing count value to and/or from the middle reference count value,

the control section compares the current count value acquired by the movement sensor when the opening and closing body is set in the predetermined state with the latch mechanism, with the middle reference count value, and corrects the current count value, and

the control section determines that the opening and closing body has arrived at the fully-closed position when the opening and closing body has moved by an amount corresponding to the pushing count value from a count value corresponding to the middle reference count value, and stops driving of the opening and closing body drive section.

### Advantageous Effects of Invention

According to the present invention, it is made possible to suppress application of an excessive load onto an opening and closing body drive section at the time of driving an opening and closing body.

### BRIEF DESCRIPTION OF DRAWINGS

FIG. 1 is a schematic side view of an automobile including an opening and closing body drive device of an embodiment of the present invention,

FIG. 2 is a partial cross-sectional view of an exemplary main configuration of an opening and closing body drive section of the opening and closing body drive device of the present embodiment,

FIG. 3 is a cross-sectional view taken along an A-A line illustrated in FIG. 2 which is a partial cross-sectional view of the exemplary main configuration of the opening and closing body drive section of the opening and closing body drive device of the present embodiment,

FIG. 4 is a partially enlarged side view of a rear portion of the automobile including the opening and closing body drive device of the present embodiment,

FIG. 5A is a diagram illustrating a fully-latched state in a latch mechanism,

FIG. 5B is a diagram illustrating how transition from the fully-latched state to a half-latched state is made in the latch mechanism,

FIG. 5C is a diagram illustrating the half-latched state in the latch mechanism,

FIG. 5D is a diagram illustrating an unlatched state in the latch mechanism,

FIG. 6 is a block diagram provided for describing a control system of the opening and closing body drive device, and

FIG. 7 is a flowchart provided for describing opening and closing body drive control in the opening and closing body drive device.

### DESCRIPTION OF EMBODIMENTS

Hereinafter, an embodiment of the present invention will be described in detail with reference to the drawings. Note that, an automobile which controls opening and closing of a back door is illustrated in the present embodiment, as an example of opening and closing drive device 1, but opening and closing drive device 1 is also applicable to a device which controls opening and closing of a shutter, a sliding door or a hinged door installed at a structure such as a store, a garage, or foldable eaves disposed above an opening of a front of the structure.

[Overall Configuration of Opening and Closing Body Drive Device]

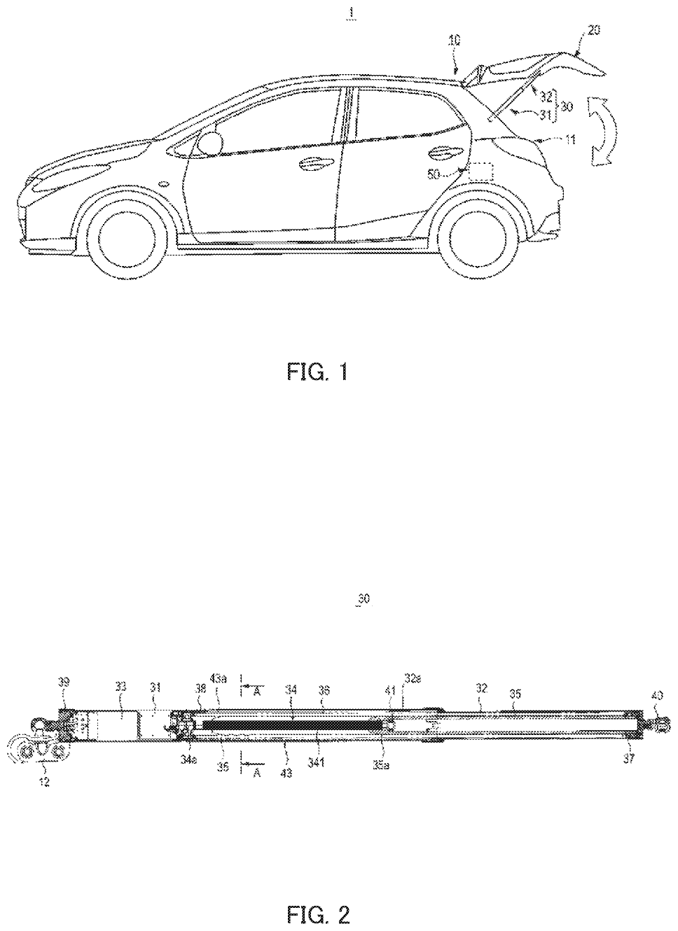

FIG. 1 is a schematic side view of an automobile including an opening and closing body drive device of the present embodiment.

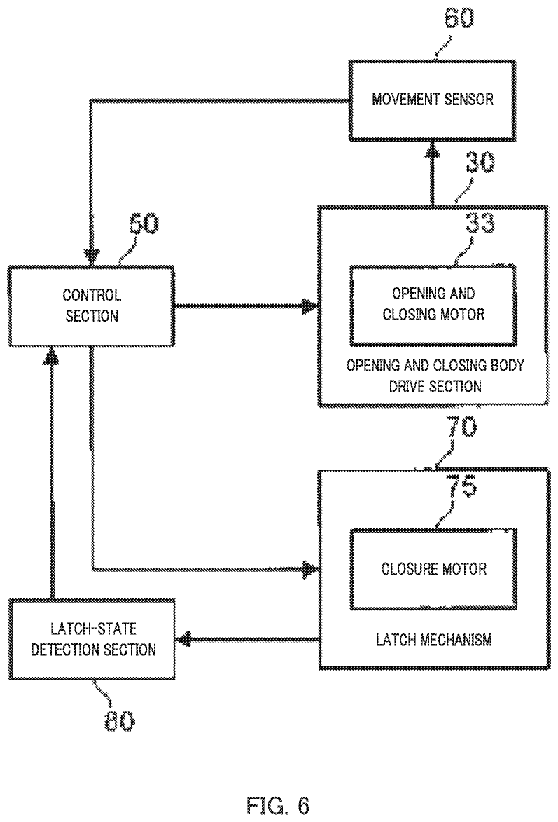

As illustrated in FIG. 1, opening and closing body drive device 1 includes opening member 10 which includes opening 11, opening and closing body 20, opening and closing body drive section 30, control section 50, movement sensor 60 (see FIG. 6), latch mechanism 70 (see FIG. 4), and latch-state detection section 80 (see FIG. 6).

Opening and closing body drive device 1 is a device which sets opening 11 of opening member 10 to an open state and a closed state by moving opening and closing body 20.

[Opening Member]

Opening member 10 is provided in a rear portion with respect to a traveling direction of a vehicle body in an automobile using opening and closing body drive device 1 of the present embodiment. Opening member 10 is a vehicle body used in this automobile and opening 11 is formed by an edge portion of opening member 10. The shape of opening 11 may be any shape including a rectangular shape, a circular shape and/or the like.

[Opening and Closing Body]

Opening and closing body 20 sets opening 11 of opening member 10 to an open state (see FIG. 1) or a closed state (see FIG. 4). At the rear side of a vehicle, the open state of opening 11 is a state where loading and unloading of an object, such as a luggage, into or from a rear trunk via opening 11 from outside is allowed. The closed state of opening 11 is a state where opening 11 is covered. In other words, when opening and closing body 20 is in a position to block this object, such as a luggage, from passing through opening 11 and moving to an opposite side, opening and closing body 20 can set opening 11 to the closed state. Further, when opening and closing body 20 is in a position to allow the object to pass through opening 11 and move to the opposite side, opening and closing body 20 can set opening 11 to the open state.

In the present embodiment, an upper side portion of opening and closing body 20 is turnably attached to a side of an upper edge portion of opening 11 in opening member 10 via a shaft portion serving as a hinge. Opening and closing body 20 sets opening 11 to the open state or closed state by pivoting such that a side of a lower side portion of opening and closing body 20 vertically moves around the shaft portion, and thus coming into contact with or separating from opening 11. In the present embodiment, the positional change of opening and closing body 20 is achieved by the pivoting mechanism described above, but the mechanism for the positional change of opening and closing body 20 is not limited to pivoting and may be any mechanism as long as opening 11 can be set to the open state and closed state.

[Opening and Closing Body Drive Section]

Opening and closing body drive section 30 moves opening and closing body 20 in an opening direction or a closing direction with respect to opening 11 of opening member 10. More than one opening and closing body drive section 30 may be provided. In the present embodiment, opening and closing body drive section 30 is provided one each in total of two to both left and right edges of opening and closing body 20 and both left and right edges of opening 11. Opening and closing body 20 is relatively moved with respect to opening member 10 by moving opening and closing body 20 by driving respective opening and closing body drive sections 30, and thus, opening 11 is set to the open state or the closed state.

As long as two opening and closing body drive sections 30 are capable of moving opening and closing body 20 in a direction in which opening 11 is set to the open state (opening direction) and in a direction in which opening 11 is set to the closed state (closing direction), respective opening and closing body drive sections 30 may drive opening and closing body 20 in the same direction with the same driving amount. Further, as long as two respective opening and closing body drive sections 30 are capable of moving opening and closing body 20 in the opening direction and in the closing direction, two opening and closing body drive sections 30 may be configured to drive opening and closing body 20 in different directions with different driving amounts. In the present embodiment, opening and closing body drive sections 30 are provided so as to perform the same driving in synchronization with each other.

Opening and closing body drive sections 30 are provided between opening member 10 and opening and closing body 20 such that opening and closing body 20 is relatively movable with respect to opening member 10. In order for opening and closing body 20 to pivotably move with respect to opening member 10, each opening and closing body drive section 30 is attached to opening member 10 so as to be capable of moving opening and closing body 20 by driving while pivoting with respect to opening member 10, which is a vehicle body.

More specifically, each opening and closing body drive section 30 has a telescopic bar shape appearance and telescopically drives by relative movement of two portions. Each opening and closing body drive section 30 includes a driving main-body portion and a forward-backward moving section. The driving main-body portion is disposed on a side of one end portion of opening and closing body drive section 30 and is connected to a side of opening member 10. The forward-backward moving section is disposed on a side of the other end portion of opening and closing body drive section 30 and is connected to a side of opening and closing body 20. The forward-backward moving section is attached so as to be capable of protruding and receding from a side of the other end portion of the driving main-body portion.

Opening and closing body drive section 30 can move, by moving the forward-backward moving section forward and backward in a longitudinal direction of opening and closing body drive section 30 with respect to the driving main-body portion, opening and closing body 20 to a fully-closed position, i.e., the position where opening and closing body 20 completely covers opening 11, and to a fully-open position, i.e., the position where opening 11 becomes a state where opening 11 is opened to a maximum extent. Each opening and closing body drive section 30 moves opening and closing body 20 in the opening direction or the closing direction by converting a rotary motion of a motor or the like into an extension and retraction motion in a linear direction.

Opening and closing body drive sections 30 are provided one each to both left and right ends of the rear potion of the automobile in total of two, but the number of opening and closing body drive sections 30 to be used is not particularly limited. Further, as long as opening and closing body drive section 30 enables opening and closing of opening and closing body 20, the structure, shape and/or installation position of opening and closing body drive section 30 is not particularly limited.

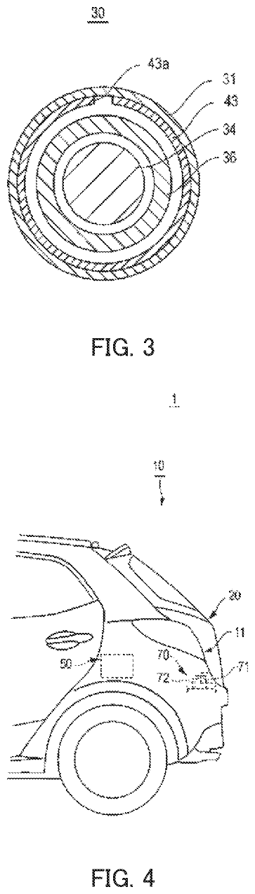

FIG. 2 is a partial cross-sectional view of an exemplary main configuration of the opening and closing body drive section of the opening and closing body drive device of the present embodiment. FIG. 3 is a cross-sectional view taken along an A-A line illustrated in FIG. 2.

In the present embodiment, opening and closing body drive section 30 includes main-body cylinder portion 31, sliding cylinder portion 32, opening and closing motor 33, spindle 34, spindle nut 35, and energizing member 36 and/or the like in this embodiment. In opening and closing body drive section 30, main-body cylinder portion 31, opening and closing motor 33, spindle 34, and energizing member 36 and/or the like correspond to the driving main-body portion, and sliding cylinder portion 32 and spindle nut 35 correspond to the forward-backward moving section.

Main-body cylinder portion 31 is rotatably fixed to opening member 10 on a side of one end portion of main-body cylinder portion 31 and is opened on a side of the other end thereof. Sliding cylinder portion 32 is disposed inside of main-body cylinder portion 31 such that sliding cylinder portion 32 is slidingly movable in the longitudinal direction so as to protrude and recede from the side of the other end portion of main-body cylinder portion 31.

Note that, fixing end portion 39 which covers the opening of one end side is provided on one end side of main-body cylinder portion 31. Fixing end portion 39 includes a ball socket section. By connecting a ball of attachment member 12 to be fixed to opening member 10 to the ball socket section, main-body cylinder portion 31 is connected to opening member 10 in a freely turnable manner.

Opening and closing motor 33 drives to move the forward-backward moving section in the longitudinal direction with respect to the driving main-body section to extend and retract opening and closing body drive section 30. Opening and closing motor 33 is a DC motor or an AC motor. In a case where opening and closing body drive device 1 is applied to an automobile, a DC motor is preferably adopted as opening and closing motor 33 in considering that a DC power supply of the automobile is used. Note that, opening and closing motor 33 is connected to control section 50, and rotational driving of rotation of both forward rotation and reverse rotation is controlled by control section 50.

Base-end portion 34a of spindle 34 which extends in the longitudinal direction and which is disposed inside of sliding cylinder portion 32 is connected to opening and closing motor 33.

Spindle 34 is disposed coaxially with a rotation shaft of opening and closing motor 33 and coupled to the rotation shaft of opening and closing motor 33 by base-end portion 34a. Spindle 34 is disposed rotatably about the axis via a bearing at main-body cylinder portion 31 on a side of base-end portion 34a.

Male-screw portion 341 is formed on an outer periphery of spindle 34, that is, a spiral groove is formed, and male-screw portion 341 is screwed into spindle nut 35. Spindle 34 corresponds to “shaft member” of the present invention.

Spindle nut 35 is driven by rotation of spindle 34 and moves on spindle 34 in a rotational axis direction of spindle 34. More specifically, spindle nut 35 is capable of moving forward and backward in the rotational axis direction (length direction) by rotation of spindle 34. Spindle nut 35 corresponds to “nut member” of the present invention.

More specifically, spindle nut 35 has a cylindrical body, and is provided, on an inner peripheral surface on a base end side, with female screw portion 35a which is screwed with male screw portion 341 on the outer periphery of spindle 34.

A leading-end portion of spindle 34 is disposed within spindle nut 35, and bearing 41 is attached to the leading-end portion of spindle 34. The leading-end portion of spindle 34 is longitudinally freely movable via bearing 41 within spindle nut 35.

The other end portion of spindle nut 35 is fixed to slide end portion 40 via lid portion 37 together with the other end portion of sliding cylinder portion 32.

Energizing member 36 energizes slide end portion 40 in a direction away from fixing end portion 39 and generates a force in a direction in which opening and closing body drive section 30 extends, such that the force acts against its own weight of opening and closing body 20 which is supported by opening and closing body drive section 30.

When an operation to open opening and closing body 20 is performed by opening and closing body drive section 30, i.e., when sliding cylinder portion 32 is moved in an extension direction, the load of opening and closing body 20, which is applied due to its own weight of opening and closing body 20 when opening and closing motor 33 rotates spindle nut 35, can be reduced by the force in the extension direction, which is generated by energizing member 36.

Energizing member 36 herein is a coil spring and is disposed inside of sliding cylinder portion 32 and around spindle nut 35. Energizing member 36 is interposed between coil base 38 and slide end portion 40.

Although coil base 38 is fixed within main-body cylinder portion 31 by the energizing force of energizing member 36, coil base 38 may be fixed by an adhesive, welding, and/or the like.

Sliding cylinder portion 32 is configured to protrude from the other end portion of main-body cylinder portion 31 and to extend and retract as an entirety of opening and closing body drive section 30 by sliding movement of sliding cylinder portion 32 in the longitudinal direction.

Sliding cylinder portion 32 has protruding portion 32a on an outer periphery of sliding cylinder portion 32.

Guide cylinder portion 43 is disposed between sliding cylinder portion 32 and main-body cylinder portion 31 surrounding sliding cylinder portion 32.

Guide cylinder portion 43 is disposed inside of main-body cylinder portion 31, and the rotation in a direction about the axis is regulated by coil base 38, and guide cylinder portion 43 includes guide portion 43a having a groove shape which extends longitudinally. In guide portion 43a, protruding portion 32a of sliding cylinder portion 32 is disposed. Although sliding cylinder portion 32 is longitudinally movable, the rotation of sliding cylinder portion 32 in a circumferential direction is regulated. For this reason, guide cylinder portion 43 regulates rotation of spindle nut 35 about the axis of spindle nut 35 fixed to slide end portion 40 together with the other end portion of slide cylinder portion 32. Guide cylinder portion 43 corresponds to “rotation regulation portion” of the present invention.

In opening and closing body drive section 30 configured in the manner described above, spindle 34 rotates when opening and closing motor 33 is driven, and spindle nut 35 regulated to be movable only longitudinally via sliding cylinder portion 32 moves longitudinally by the rotation of spindle 34. The forward-backward moving section moves with this movement of spindle nut 35, and thus slide end portion 40 moves. Since opening and closing body 20 is connected to slide end portion 40, opening and closing body 20 itself moves in the opening direction or closing direction and can be positioned in the fully-open position and the fully-closed position.

Opening and closing body drive section 30 includes a configuration in which spindle nut 35 is screwed with spindle 34. This configuration is a self-lock mechanism which restricts movement of spindle nut 35 by friction between spindle 34 and spindle nut 35 even when a force to retract spindle nut 35 acts on spindle nut 35 from opening and closing body 20. When movement of spindle nut 35 is restricted in the self-lock mechanism, movement of opening and closing body 20 in the closing direction is restricted.

Note that, the self-lock mechanism included in opening and closing body drive section 30 may be a configuration including a worm wheel and a worm gear, for example, or may be another configuration and/or the like.

[Latch Mechanism]

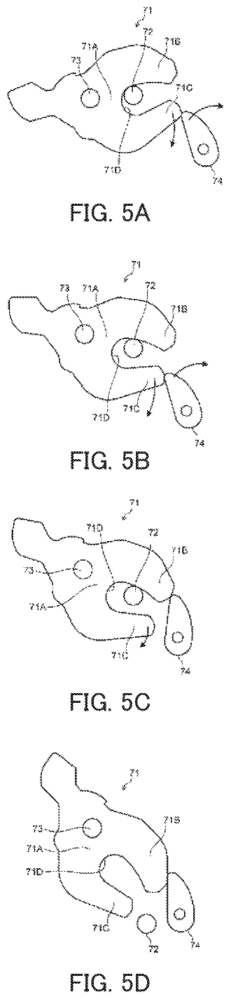

FIG. 4 is a partially enlarged side view of the rear portion of the automobile including the opening and closing body drive device of the present embodiment. FIG. 5A is a diagram illustrating a fully-latched state in a latch mechanism. FIG. 5B is a diagram illustrating how transition from the fully-latched state to a half-latched state is made in the latch mechanism. FIG. 5C is a diagram illustrating the half-latched state in the latch mechanism. FIG. 5D is a diagram illustrating an unlatched state in the latch mechanism.

As illustrated in FIG. 4 and FIG. 5A, latch mechanism 70 is a mechanism provided for performing movement regulation of opening and closing body 20 in a closed state with respect to opening 11. Latch mechanism 70 includes latch 71, striker 72, rotation shaft 73, pole 74, and closure motor 75 (see FIG. 6).

Latch 71 is a member engageable with striker 72 and provided on an inner-side lower end portion of opening and closing body 20. Latch 71 includes base portion 71A, first arm 71B which extends from an upper end portion of base portion 71A, and second arm 71C which extends from a lower end portion of base portion 71A. First arm 71B and second arm 71C each extend in the same direction (in the direction from left to right in FIG. 5A) from base portion 71A.

Striker 72 is a member engageable with latch 71 and includes a rod-shape portion capable of entering recess portion 71D formed by base portion 71A, first arm 71B, and second arm 71C of latch 71. For example, a portion parallel in the left and right direction in FIG. 4 is the rod-shape portion of striker 72.

Striker 72 is provided in a position such that the rod-shape portion is engaged with latch 71 in a fully-latched state when opening and closing body 20 is set in a closed state in a lower edge portion of opening 11 in opening member 10. Note that, in a case where latch 71 is provided on a side of opening member 10, striker 72 is provided on a side of opening and closing body 20.

Latch 71 is configured to be rotatable about rotation shaft 73. Latch 71 transitions between a fully-latched state (state in FIG. 5A), a half-latched state (state in FIG. 5C), and an unlatched state (state in FIG. 5D) by rotation due to a driving force of closure motor 75, for example.

The fully-latched state is a fully-engaged state in which engagement is made such that striker 72 cannot be separated from recess portion 71D of latch 71. The half-latched state is a state in which the engagement force between latch 71 and striker 72 is smaller than the engagement force in the fully-latched state, and striker 72 can be readily separated from recess portion 71D of latch 71 by application of an external force. The unlatched state is a state in which latch 71 and striker 72 are completely disengaged from each other.

Further, latch 71 may be energized by an energizing member (not illustrated) so as to rotate in a clockwise direction in FIG. 5A to FIG. 5D. Thus, by controlling rotation of pole 74 to be described later, latch 71 can be caused to rotate from the fully-latched state to the unlatched state by the energizing force of the energizing member.

Pole 74 is a member capable of regulating rotation of latch 71 and is provided in a position where pole 74 is capable of coming into contact with any of first arm 71B and second arm 71C of latch 71. Pole 74 is provided rotatably and is controlled under driving of closure motor 75 so as to be positioned in a first position (see FIG. 5A), a second position (see FIG. 5C), and a third position (see FIG. 5D) from an upstream side in the clockwise direction.

An example of an operation in latch mechanism 70 will be described, herein. First, an operation for transition from the fully-latched state to the unlatched state will be described.

As illustrated in FIG. 5A, when pole 74 is in the first position, a leading end of second arm 71C in latch 71 in the fully-latched state comes into contact with pole 74. Thus, rotation of latch 71 is regulated, and thus, the fully-latched state of latch 71 is maintained.

As illustrated in FIG. 5B, when pole 74 rotates in the clockwise direction from the first position, the contact state with second arm 71C is released. Latch 71 rotates in the clockwise direction by the driving force of closure motor 75.

As illustrated in FIG. 5C, when pole 74 further rotates and is positioned in the second position, pole 74 and first arm 71B of latch 71 come into contact with each other. At this time, latch 71 is in the position of the half-latched state, and the half-latched state of latch 71 is maintained by regulation of rotation of latch 71 by pole 74.

As illustrated in FIG. 5D, when pole 74 further rotates and is positioned in the third position, the contact state between pole 74 and first arm 71B of latch 71 is released. Thus, latch 71 rotates in the clockwise direction by the driving force of closure motor 75 and is positioned in the position of the unlatched state. More specifically, latch 71 and striker 72 are completely disengaged from each other.

Moreover, the engagement force between latch 71 and striker 72 in the half-latched state is small as compared with the engagement force in the fully-latched state even without rotation of pole 74 from the second position. For this reason, it is possible to disengage latch 71 and striker 72 from each other by the force to move opening and closing body 20 in the opening direction due to the driving force of opening and closing motor 33.

Next, an operation for transition from the unlatched state to the fully-latched state will be described. First, as illustrated in FIG. 5C and FIG. 5D, by movement of opening and closing body 20 by opening and closing drive section 30 from the position of the unlatched state, latch 71 is engaged with striker 72, and thus, latch mechanism 70 is set in the half-latched state.

Further, under the control of control section 50 to be described later, opening and closing motor 33 and closure motor 75 operate, and as illustrated in FIG. 5B, latch 71 is rotated in a counterclockwise direction so as to pull striker 72 into recess portion 71D of latch 71, and thus, latch mechanism 70 is set in the fully-latched state.

Note that, as long as latch mechanism 70 has a configuration capable of being driven by closure motor 75, latch mechanism 70 may adopt any configuration.

[Configuration of Control System]

FIG. 6 is a block diagram illustrating a control system of opening and closing body drive device 1.

In opening and closing body drive device 1, the control system includes control section 50, movement sensor 60, and latch-state detection section 80. The control system of opening and closing body drive device 1 controls opening and closing body 20 driven by opening and closing body drive section 30 including opening and closing motor 33.

[Movement Sensor]

Movement sensor 60 detects movement of a position of opening and closing body 20 by detecting, for example, an operation of opening and closing body drive section 30, and outputs movement information on opening and closing body 20, which is a result of the detection, to control section 50.

Movement sensor 60, for example, includes Hall elements, and detects the operation of opening and closing body drive section 30, that is, movement of the position of opening and closing body 20 by magnetically detecting a rotation state of opening and closing motor 33. In this case, magnets are positioned circumferentially with different intervals on a disk provided on the rotation shaft of opening and closing motor 33, and the Hall elements of movement sensor 60 are disposed in positions facing the magnets. Pulses are generated by capturing magnets moving along with the rotation of the rotation shaft of opening and closing motor 33 by the Hall elements. Control section 50 computes the position of opening and closing body 20 by a count value resulting from counting of the pulses and computes a driving speed of opening and closing body 20 by a change in the count value.

Movement sensor 60 counts the captured pulses, and control section 50 uses the count value as the movement information on opening and closing body 20 and makes the count value of the pulses usable for computing the position and the driving speed of opening and closing body 20 in control section 50. Note that, it is also possible to adopt a configuration in which movement sensor 60 not only counts pulses but also computes the position and the driving speed of opening and closing body 20 based on the count value and outputs the result of computation to control section 50.

Further, as long as movement sensor 60 is capable of detecting information on movement of the position of opening and closing body 20, movement sensor 60 may adopt any configuration, and for example, movement sensor 60 may be configured to directly detect movement of the position of opening and closing body 20 without detecting an operation of opening and closing body drive section 30. The detection method is not limited to the detection performed magnetically using Hall elements, and any method may be adopted as long as a count value in accordance with the position of opening and closing body 20 can be generated. Further, although movement sensor 60 has been described as a sensor that is provided separately from control section 50 to be described later, movement sensor 60 may be a sensor incorporated into control section 50.

Note that, control section 50 may be configured to acquire a previously set count value from a storage section and/or the like, for example, in accordance with the result of output from movement sensor 60 in a case where movement sensor 60 outputs an output value other than a count value to control section 50.

[Latch-State Detection Section]

Latch-state detection section 80 detects a latch state of latch mechanism 70 and outputs the result of detection to control section 50. Latch-state detection section 80, for example, detects a latch state, such as a half-latched state, based on a rotation state of latch 71, for example.

Latch-state detection section 80 includes a half-latch detection switch that transitions to an ON state when latch 71 is set in the state in FIG. 5C and transitions to an OFF state when latch 71 is set in a state other than the state in FIG. 5C. More specifically, latch mechanism 70 is provided with a link mechanism (not illustrated), and the half-latch detection switch switches between the ON state and the OFF state in accordance with the rotation state of latch 71 via the link mechanism. Thus, control section 50 to be described later determines whether or not latch mechanism 70 is in a half-latched state, based on a signal of the ON state and a signal of the OFF state which are outputted from latch-state detection section 80.

Further, latch-state detection section 80 may include a switch capable of detecting the unlatched state and/or the fully-latched state.

Moreover, as long as latch-state detection section 80 is capable of detecting a latch state of latch mechanism 70, latch-state detection section 80 may be any detection part.

Further, latch-state detection section 80 may not be provided in opening and closing body drive device 1. In this case, opening and closing body drive device 1 may be configured to acquire a detection signal of the latch state from an outside.

[Control Section]

Control section 50 includes a central processing unit (CPU), a read only memory (ROM), and a random access memory (RAM) and/or the like. The CPU reads a program from the ROM in accordance with a processing content, loads the program into the RAM, and performs centralized control for operation of each block of opening and closing body drive device 1 in cooperation with the loaded program. At this time, various types of data stored in a storage section (illustration is omitted) are referred to. The storage section (illustration is omitted) is, for example, formed of a nonvolatile semiconductor memory (so-called flash memory) and/or a hard disk drive. Control section 50, for example, may be incorporated into an electronic control unit (ECU) which controls each part of a vehicle, or may be mounted on opening and closing body drive section 30.

Control section 50 acquires movement information on opening and closing body 20, which is outputted from movement sensor 60, and controls opening and closing movement of opening and closing body 20 via opening and closing body drive section 30, using the movement information. More specifically, control section 50 determines the position of opening and closing body 20 based on the result of detection of movement sensor 60. The position information on opening and closing body 20 determined by control section 50 is stored in the storage section (illustration is omitted) as needed. Further, in a case where an operation instruction and/or the like of opening and closing body 20 is present, control section 50 controls the driving speed of opening and closing body 20 in accordance with the current position information on opening and closing body 20.

The position information, for example, corresponds to the count value of pulses outputted from movement sensor 60, and each position is previously set in accordance with the count value. For example, in a case where the count value in the fully-closed position of opening and closing body 20 is 0 while the count value in the fully-open position of opening and closing body 20 is 1500, setting is made such that each position from the fully-closed position to the fully-open position increases within a range of count values 0 to 1500 as the position moves from the fully-closed position in the opening direction.

Control section 50 controls a driving speed of opening and closing body 20 based on the current count value, which is the current count value of pulses. For example, in a case where opening and closing body 20 is moved from the fully-open position to the fully-closed position, control section 50 controls the driving speed of opening and closing body 20 such that the driving speed of opening and closing body 20 becomes a predetermined target speed.

The predetermined target speed is a target speed which is previously set for opening and closing body 20, and for example, the predetermined target speed can be a speed that makes it possible to avoid, by avoiding behavior in accordance with the position of opening and closing body 20, pinching and/or collision at opening and closing body 20 that occurs due to movement of opening and closing body 20 during an opening and closing operation of opening and closing body 20.

When opening and closing body 20 moves to the position where latch mechanism 70 is set in the half-latched state in the vicinity of the fully-closed position, control section 50, for example, determines that latch mechanism 70 has been set in the half-latched state, based on the result of detection of latch-state detection section 80 to be described later. Control section 50 then drives closure motor 75 in latch mechanism 70.

Opening and closing body drive section 30, herein, includes a self-lock mechanism as described above. Even when a force for movement in the closing direction acts on opening and closing body 20 due to the driving force of closure motor 75 in a case where transition from the half-latched state to the fully-latched state is made, a force to prevent opening and closing body 20 from rotating acts on opening and closing body 20 due to the self-lock mechanism included in opening and closing body drive section 30. Thus, the driving force of closure motor 75 is cancelled out by the force to lock by the self-lock mechanism, and movement of opening and closing body 20 in the closing direction is hindered. Further, examples of causes to hinder movement of opening and closing body 20 in the closing direction include a reactive force of a rubber piece and/or the like included in opening and closing body 20, and/or a slope, bad weather, and/or the like in addition to the self-lock mechanism.

In this respect, control section 50 moves opening and closing body 20 to the fully-closed position, using the driving force of opening and closing motor 33 in addition to closure motor 75. In this manner, latch mechanism 70 in the half-latched state can be surely set in the fully-latched state, and as a result, opening and closing body 20 can be moved to the fully-closed position.

Meanwhile, the half-latched position of opening and closing body 20 in the half-latched state is a position which deviates in the opening direction with respect to the fully-latched position of opening and closing body 20 in the fully-latched state. For this reason, the count value in movement sensor 60 becomes a count value that varies between the half-latched position and the fully-latched position.

In this embodiment, for example, an assumption is made herein that the following setting is made: the count value for the fully-closed position (fully-latched position) of opening and closing body 20 is 0, the count value for the fully-open position of opening and closing body 20 is 1500, and each position from the fully-closed position to the fully-open position increases within a range of count values 0 to 1500 as the position moves from the fully-closed position in the opening direction. Further, the count value for the half-latched position is set to 20 in this case. In this case, the movement amount of opening and closing body 20 required for causing a movement from the half-latched state to the fully-latched state becomes 20 count values.

There is, however, a possibility that the current count value in movement sensor 60 (hereinafter, referred to as “current count value”) becomes a value that deviates from the previously set count value at which latch 71 is set in the predetermined state (hereinafter, referred to as “middle reference count value”) as a result of an error possibly made by movement sensor 60 in counting of pulses, and/or movement of opening and closing body 20 caused by an external force in a sleep state of control section 50, which possibly occurs, for example, while the opening and closing operation of opening and closing body 20 is repeatedly performed. Examples of cases where the current count value and the middle reference count value deviate from each other include a case where movement sensor 60 misses slight movement of opening and closing body 20 caused by an external force.

Control section 50 compares the current count value and the middle reference count value with each other when latch mechanism 70 is set in the predetermined state, for example, the half-latched state, according to the result of detection of latch-state detection section 80. In a case where the current count value and the middle reference count value are different from each other, control section 50 corrects the current count value. Suppose that the predetermined state is the half-latched state, herein, since the count value for the half-latched position is 20, the middle reference count value becomes 20. In this case, correction of the current count value is made in this embodiment when the current count value for the half-latched state is a value not 20, e.g., 30.

As a correction method for the current count values, any method may be used, including, for example, replacement of the current count value with the count value of the middle reference count value, and/or addition of a difference between the current count value and the middle reference count value to the current count value.

After correcting the current count value, control section 50 stops driving of opening and closing body drive section 30 by determining that opening and closing body 20 has arrived at the fully-closed position, when opening and closing body 20 has moved by an amount corresponding to a pushing count value from a count value corresponding to the middle reference count value, that is, the corrected current count value. Note that, the count value corresponding to the middle reference count value need not necessarily be a value equal to the corrected current count value, and for example, may be a value around the corrected current count value, e.g., a value which deviates by roughly one or two count values from the corrected current count value.

The pushing count value is a count value corresponding to the movement amount required from the half-latched position to the fully-closed position. More specifically, opening and closing body 20 is set in the fully-closed state by adding or subtracting the pushing count value to or from the middle reference count value.

More specifically, control section 50 controls the driving speed of opening and closing body 20 such that the driving speed becomes 0 when opening and closing body 20 arrives at the fully-closed position, by causing opening and closing body 20 in the half-latched position to move at a driving speed corresponding to the corrected current count value and gradually reducing the driving speed.

When latch mechanism 70 is in the half-latched state, the middle reference count value becomes 20. However, suppose that, when opening and closing body 20 is moved with the current count value without the current count value correction of this embodiment without any change in a case where the current count value is, for example, 30, opening and closing body 20 attempts to move further even after opening and closing body 20 arrives at the fully-closed position.

For the case described above, in this embodiment, the current count value is corrected from 30 to 20, and opening and closing body 20 is moved only by the amount corresponding to the corrected current count value. In this manner, the moving amount of opening and closing body 20 by opening and closing body drive section 30 from the half-latched state can be set to an appropriate moving amount. Thus, it is made possible to suppress a case where opening and closing motor 33 keeps rotating, for example, even after opening and closing body 20 arrives at the fully-closed position. For this reason, it is also made possible to suppress application of a load onto opening and closing motor 33 itself, such as application of an overcurrent to opening and closing motor 33, and/or to suppress application of an excessive load onto opening and closing body drive section 30, such as a case where spindle nut 35 and/or the like which rotates by rotation of opening and closing motor 33 spins around.

Further, the driving speed of opening and closing body 20 is controlled using the corrected current count value. In this embodiment, the driving speed of opening and closing body 20 is variably controlled in accordance with the position of opening and closing body 20, which can be found from the corrected current count value. For example, a position in the vicinity of the half-latched position is a position immediately before the fully-closed position for opening and closing body 20, and thus, the control is performed such that the speed of opening and closing body 20 is gradually reduced from a predetermined speed to the speed 0, which is equivalent to the stop state. More specifically, the driving speed of opening and closing body 20 varies in the vicinity of the half-latched position. Suppose that the driving speed of opening and closing body 20 is controlled without correction of the current count value, there occurs a phenomenon in which opening and closing body 20 operates at a driving speed faster than expected, for example. Meanwhile, in this embodiment, the current count value is corrected at the time of the half-latched state, and thus, the driving speed at the time of moving opening and closing body 20 from the half-latched state can be an appropriate driving speed. For this reason, occurrence of the phenomenon in which opening and closing body 20 operates at a driving speed faster than expected can be suppressed.

Note that, although a description of the predetermined state has been given as the half-latched state, as long as the position of opening and closing body 20 can be identified in accordance with the state of latch mechanism 70, the predetermined state can be a state other than the half-latched state.

[Driving Control of Opening and Closing Body in Opening and Closing Body Drive Device]

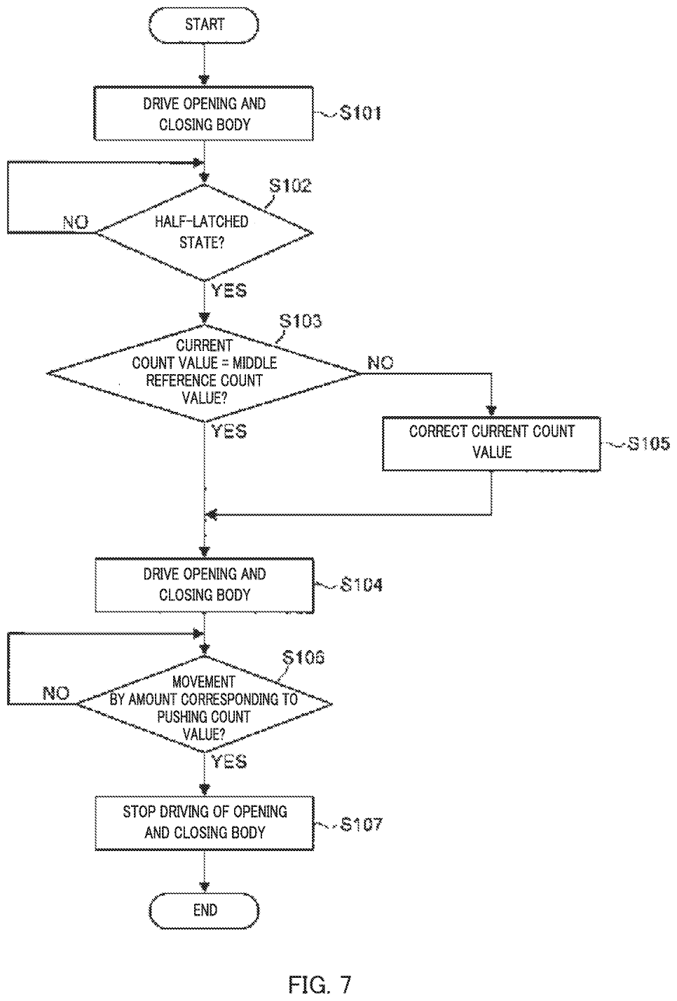

FIG. 7 is a flowchart provided for describing opening and closing body drive control in opening and closing body drive device 1. Note that, the control in FIG. 7 assumes that the control is one that is performed when control section 50 receives an operation instruction to set opening and closing body 20 in the closing state, while opening and closing body 20 is in the open state.

As indicted in FIG. 7, control section 50 controls opening and closing body drive section 30 so as to drive opening and closing body 20 (step S101). Next, control section 50 determines whether or not latch mechanism 70 is in the half-latched state, based on a result of detection of latch-state detection section 80 (step S102).

In a case where latch mechanism 70 is not in the half-latched state as a result of the determination (step S102, NO), the processing of step S102 is repeated. Meanwhile, in a case where latch mechanism 70 is in the half-latched state as the result of determination (step S102, YES), control section 50 determines whether or not the current count value is equal to the middle reference count value (step S103).

In a case where the current count value is equal to the middle reference count value as a result of the determination (step S103, YES), control section 50 drives opening and closing body 20, using the current count value (step S104). Note that, in step S104, latch mechanism 70 is also driven in addition to driving of opening and closing body 20.

Meanwhile, in a case where the current count value is not equal to the middle reference count value (step S103, NO), control section 50 corrects the current count value (step S105). After step S105, the processing transitions to step S104. More specifically, control section 50 drives opening and closing body 20, using the corrected current count value.

Next, control section 50 determines whether or not opening and closing body 20 has moved by the amount corresponding to the pushing count value (step S106). In a case where opening and closing body 20 has not moved by the amount corresponding to the pushing count value as a result of the determination (step S106, NO), the processing of step S106 is repeated. Meanwhile, in a case where opening and closing body 20 has moved by the amount corresponding to the pushing count value (step S106, YES), control section 50 stops driving of opening and closing body 20 (step S107). This control is then terminated.

According to the present embodiment described above, when latch mechanism 70 is in a predetermined state, for example, in a half-latched state, the current count value is corrected in accordance with the current count value from movement sensor 60. Thus, the current count value in movement sensor 60 can be made appropriate, and thus, the movement amount of opening and closing body 20 by opening and closing body drive section 30 from the half-latched state, which is the predetermined state, can be an appropriate movement amount, accordingly. For this reason, it is made possible to suppress a case where, for example, opening and closing motor 33 keeps rotating after opening and closing body 20 arrives at the fully-closed position, and thus, it is also made possible to suppress application of an excessive load onto opening and closing body drive section 30 at the time of driving of opening and closing body 20.

Further, the driving speed of opening and closing body 20 is controlled, using the corrected current count value, and thus, the driving speed at the time of moving opening and closing body 20 from the half-latched state can be an appropriate driving speed. For this reason, occurrence of the phenomenon in which opening and closing body 20 operates at a driving speed faster than expected can be suppressed, and consequently, the accuracy of driving speed control for opening and closing body 20 can be improved. For this reason, driving that causes opening and closing body 20 to move relatively fast in a region where opening and closing body 20 moves relatively slow can be prevented.

Further, in the present embodiment, a signal of latch-state detection section 80 or the like, which is capable of accurately recognizing the position of opening and closing body 20, is used, and thus, the current count value in movement sensor 60 can be made appropriate with a simple configuration.

The embodiment disclosed this time is only exemplary in every aspect and should be considered nonrestrictive. The scope of the present invention is indicated not by the description above but by claims, and it is intended that every change within meaning or range equivalent to the claims is included.

The embodiment of the present invention has been described thus far. Note that, the above description is only illustration of a preferred embodiment of the present invention, and the scope of the present invention is not limited to this. That is, the descriptions of the configuration of the above-mentioned device and the shape of each portion are only exemplary, and it is obvious that various changes and additions to these examples are possible within the scope of the present invention.

### Industrial Applicability

The opening and closing body driving device according to the present invention is useful as an opening and closing body driving device capable of suppressing application of an excessive load onto an opening and closing body drive section at the time of driving of an opening and closing body.

### REFERENCE SIGNS LIST

1 Opening and closing body drive device
10 Opening member
11 Opening
12 Attachment member
20 Opening and closing body
30 Opening and closing body drive section
31 Main-body cylinder portion
32 Sliding cylinder portion
32a Protruding portion
33 Opening and closing motor
34 Spindle
35 Spindle nut
36 Energizing member
37 Lid portion
38 Coil base
39 Fixing end portion
40 Slide end portion
41 Bearing
43 Guide tubular portion
43a Guide portion
50 Control section
60 Movement sensor
70 Latch mechanism
71 Latch
71A Base portion
71B First arm
71C Second arm
71D Recess portion
72 Striker
73 Rotation shaft
74 Pole
75 Closure motor
80 Latch-state detection section
341 Male-screw portion

1. An opening and closing body drive device, comprising:
an opening and closing body;
a latch mechanism which causes a striker to engage with and/or disengage from a latch and to set the opening and closing body in a closed state or an open state;
an opening and closing body drive section which causes the opening and closing body to move between a fully-open position and a fully-closed position;
a control section which controls driving of the opening and closing body drive section; and
a movement sensor which outputs movement information on the opening and closing body, wherein
the control section includes a middle reference count value which is a previously set count value when the latch mechanism is set in a predetermined state, and a pushing count value which causes the opening and closing body to be set in a fully-closed state by adding and/or subtracting the pushing count value to and/or from the middle reference count value,
the control section compares the current count value acquired by the movement sensor when the opening and closing body is set in the predetermined state with the latch mechanism, with the middle reference count value, and corrects the current count value, and
the control section determines that the opening and closing body has arrived at the fully-closed position when the opening and closing body has moved by an amount corresponding to the pushing count value from a count value corresponding to the middle reference count value, and stops driving of the opening and closing body drive section.

2. The opening and closing body drive device according to claim 1, wherein the opening and closing body drive section comprises: a shaft member including a spiral groove on an outer periphery of the shaft member; a motor which rotates the shaft member axially in a length direction; a nut member which is screwed with the shaft member and is capable of moving forward and backward along the length direction by rotation of the shaft member; and a rotation regulation member which regulates rotation of the nut member in a direction around the shaft.

3. The opening and closing body drive device according to claim 1, wherein the predetermined state of the opening and closing body with the latch mechanism is a half-latched state in the latch mechanism.

4. The opening and closing body drive device according to claim 1, wherein the control section controls a driving speed of the opening and closing body based on the current count value which has been corrected.
